(19) United States
(12) Patent Application Publication
(10) Pub. No.: US 2025/0071540 A1
(43) Pub. Date: Feb. 27, 2025

(54) METHODS, DEVICES, AND COMPUTER READABLE MEDIUM FOR COMMUNICATION

(71) Applicant: NEC CORPORATION, Tokyo (JP)

(72) Inventors: Gang WANG, Beijing (CN); Yukai GAO, Beijing (CN); Peng GUAN, Beijing (CN)

(73) Assignee: NEC CORPORATION, Tokyo (JP)

(21) Appl. No.: 18/723,303

(22) PCT Filed: Dec. 24, 2021
(86) PCT No.: PCT/CN2021/141339

§ 371 Date: Jun. 24, 2024

(51) Int. Cl. H04W 8/22; H04B 7/06; H04B 17/309; H04B 17/318; H04W 16/28; H04W 24/02

(52) U.S. Cl. CPC H04W 8/22; H04B 7/0626; H04B 17/328; H04B 17/346; H04W 16/28; H04W 24/02

(57) ABSTRACT

Embodiments of the present invention disclose methods, devices, and computer readable medium for communication. According to embodiments of the present disclosure, a terminal device reports one or more capabilities of the terminal device to a network device. The one or more capabilities indicate that the terminal device supports an artificial intelligent/machine learning (AI/ML) model. The terminal device receives an indication which triggers a channel state information (CSI) report for the AI/ML model from the network device. The terminal device measures a set of reference signals for the CSI report. In this way, the AI/ML model can be trained to improve accuracy of the beam management.

### TECHNICAL FIELD

Embodiments of the present disclosure generally relate to the field of telecommunication, and in particular, to methods, devices, and computer readable medium for communication.

### BACKGROUND

Several technologies have been proposed to improve communication performances. For example, communication devices may employ an artificial intelligent/machine learning (AI/ML) model to improve performances. In some situations, the communication devices can perform beam management based on the AI/ML model.

### SUMMARY

In general, example embodiments of the present disclosure provide a solution for communication.

In a first aspect, there is provided a method for communication. The communication method comprises: reporting, at a terminal device and to a network device, one or more capabilities of the terminal device, wherein the one or more capabilities at least indicate that the terminal device supports a data processing model; receiving, from the network device, one or more configurations associated with the data processing model; and receiving, from the network device, an indication for triggering a report for acquiring information associated with the data processing model.

In a second aspect, there is provided a method for communication. The communication method comprises: receiving, at a network device and from a terminal device, a capability report comprising one or more capabilities of the terminal device, wherein the one or more capabilities at least indicate that the terminal device supports a data processing model; transmitting, to the terminal device, one or more configurations associated with the data processing model; and transmitting, to the terminal device, an indication for triggering a report for acquiring information associated with the data processing model.

In a third aspect, there is provided a terminal device. The terminal device comprises a processing unit; and a memory coupled to the processing unit and storing instructions thereon, the instructions, when executed by the processing unit, causing the terminal device to perform acts comprising: reporting, at a terminal device and to a network device, one or more capabilities of the terminal device, wherein the one or more capabilities at least indicate that the terminal device supports a data processing model; receiving, from the network device, one or more configurations associated with the data processing model; and receiving, from the network device, an indication for triggering a report for acquiring information associated with the data processing model.

In a fourth aspect, there is provided a network device. The network device comprises a processing unit; and a memory coupled to the processing unit and storing instructions thereon, the instructions, when executed by the processing unit, causing the network device to perform acts comprising: receiving, at a network device and from a terminal device, a capability report comprising one or more capabilities of the terminal device, wherein the one or more capabilities at least indicate that the terminal device supports a data processing model; transmitting, to the terminal device, one or more configurations associated with the AI/ML model; and transmitting, to the terminal device, an indication for triggering a report for acquiring information associated with the data processing model.

In a fifth aspect, there is provided a computer readable medium having instructions stored thereon, the instructions, when executed on at least one processor, causing the at least one processor to carry out the method according to the first or second aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for communications according to some embodiments of the present disclosure;

FIG. 3A illustrates a schematic diagram of detecting a failure in the AI/ML model according to some embodiments of the present disclosure;

FIG. 3B illustrates a schematic diagram of detecting a failure in the AI/ML model according to some embodiments of the present disclosure;

FIG. 4 illustrates a schematic diagram of training the AI/ML model according to some embodiments of the present disclosure;

FIG. 5 is a flowchart of an example method in accordance with an embodiment of the present disclosure;

FIG. 6 is a flowchart of an example method in accordance with an embodiment of the present disclosure; and

FIG. 7 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device. In the following description, the terms “terminal device”, “communication device”, “terminal”, “user equipment” and “UE” may be used interchangeably.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHZ-7125 MHZ), FR2 (24.25 GHz to 71 GHZ), frequency band larger than 100 GHz as well as Terahertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest.” “highest,” “minimum.” “maximum,” or the like. It will be appreciated that such descriptions are intended to indicate that a selection among many used functional alternatives can be made, and such selections need not be better, smaller, higher, or otherwise preferable to other selections.

As mentioned above, the communication devices can perform the beam management on the AI/ML model. Massive MIMO (mMIMO) and beamforming are widely used in the telecom industry. Terms “beamforming” and “mMIMO” are sometimes used interchangeably. In general, beamforming uses multiple antennas to control the direction of a wave-front by appropriately weighting the magnitude and phase of individual antenna signals in an array of multiple antennas. The most commonly seen definition is that mMIMO is a system where the number of antennas exceeds the number of users. The coverage is beam-based in 5G, not cell based. There is no cell-level reference channel from where the coverage of the cell could be measured. Instead, each cell has one or multiple Synchronization Signal Block Beam (SSB) beams. SSB beams are static, or semi-static, always pointing to the same direction. They form a grid of beams covering the whole cell area. The user equipment (UE) searches for and measure the beams, maintaining a set of candidate beams. The candidate set of beams may contain beams from multiple cells. With 5G millimeter wave (mmWave) enabling directional communication with a larger number of antenna elements and providing an additional beamforming gain, efficient management of beams—where UE and gNB regularly identify the optimal beams to work on at any given point of time—has become crucial.

The AI/ML models may be possibly deployed in gNB at first stage. Since the gNB is more powerful at handling the data, the model and the computing load for AI/ML, it is a natural way to carry out the discussion on AI/ML for NR air-interface beginning from gNB. In case of beam prediction in spatial domain, the AI/ML model trained in gNB side is not accurate for some UEs, that is, the predicted (or inferenced) optimal beam is inconsistent with the actual optimal beam from the UE side. For example, the UE can measure qualities (e.g., layer 1reference signal received power (L1-RSRP)) of beam-F, G, J and K to estimate the qualities of all candidate beams based on the AI/ML model trained in gNB side, and the optimal beam (assuming beam-A) having the largest L1-RSRP can be determined based on the L1-RSRPs of all candidate beams. But in fact, beam-A (i.e., Rx-beam) of the UE is covered by a shelter. If beam-A is still used, the transmission quality will be seriously affected. Offline training of AI/ML model cannot take into account the occurrence of all “accidents”. In order to ensure the AI/ML model can adapt to the environment of the UE, it is necessary to attach an online training to the offline trained model. For example, the online training can be performed at the gNB side. However, in this situation, the UE needs to provide a larger amount of data required for training, which may cause huge UL overheads. Thus, the online training should be performed at UE side.

According to embodiments, solutions on improving the AI/ML model are proposed. According to embodiments of the present disclosure, a terminal device reports one or more capabilities of the terminal device to a network device. The one or more capabilities indicate that the terminal device supports an AI/ML model. The terminal device receives one or more configurations associated with the AI/ML model from the network device. The terminal device receives an indication which triggers a report for obtaining information associated with the AI/ML model from the network device. In this way, the AI/ML model can be trained to improve accuracy of the beam management.

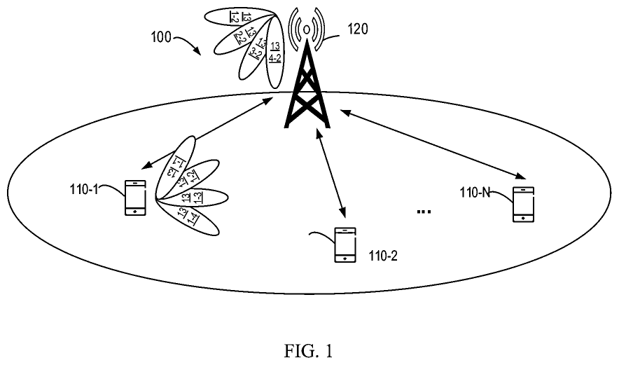

FIG. 1 illustrates a schematic diagram of a communication system in which embodiments of the present disclosure can be implemented. The communication system 100, which is a part of a communication network, comprises a terminal device 110-1, a terminal device 110-2 . . . , a terminal device 110-N, which can be collectively referred to as “terminal device(s) 110.” The number N can be any suitable integer number. The terminal devices 110 can communicate with each other. Only as an example, the terminal device 110-1 can be configured with a plurality of beams, which is shown as beams 131-1, 132-1, 133-1 and 134-41. The network device 120 can be configured with multiple beams which are shown as beams 131-2. 132-2, 133-2 and 134-2. A beam pair can comprise two beams, for example, beams 131-1 and 131-2, 132-1 and 132-2, 133-1 and 133-2, and 134-1 and 134-2. It should be noted that the number of beams shown in FIG. 1 is only an example not limitation.

The communication system 100 further comprises a network device. In the communication system 100, the network device 120 and the terminal devices 110 can communicate data and control information to each other. The numbers of terminal devices shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHZ, an extending NR operation up to 71 GHZ, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

The term “slot” used herein refers to a dynamic scheduling unit. One slot comprises a predetermined number of symbols. The term “downlink (DL) sub-slot” may refer to a virtual sub-slot constructed based on uplink (UL) sub-slot. The DL sub-slot may comprise fewer symbols than one DL slot. The slot used herein may refer to a normal slot which comprises a predetermined number of symbols and also refer to a sub-slot which comprises fewer symbols than the predetermined number of symbols.

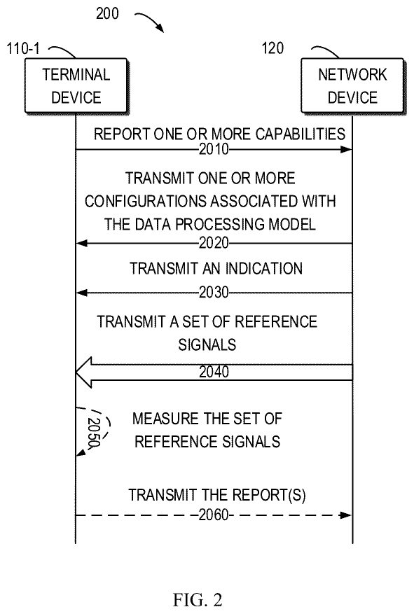

Embodiments of the present disclosure will be described in detail below. Reference is first made to FIG. 2, which shows a signaling chart illustrating process 200 between the terminal device and the network device according to some example embodiments of the present disclosure. Only for the purpose of discussion, the process 200 will be described with reference to FIG. 1. The process 200 may involve the terminal device 110-1 and the network device 120 in FIG. 1. In some embodiments, the process 200 can be applied in detecting a failure in the AI/ML model. Alternatively, the process 200 can be applied in online training of the AI/ML model.

The terminal device 110-1 reports 2010 one or more capabilities of the terminal device 110-1 to the network device 120. The one or more capabilities at least indicate that the terminal device 110-1 supports a data processing model. The data processing model can be an AI/ML model. The term “AI/ML model” used herein can refer to a program or algorithm that utilizes a set of data that enables it to recognize certain patterns. This allows it to reach a conclusion or make a prediction when provided with sufficient information. Generally, the AI/ML model can be a mathematical algorithm that is “trained” using data and human expert input to replicate a decision an expert would make when provided that same information.

In some embodiments, the capabilities can indicate a capability of supporting AI/ML. In some embodiments, the capabilities can indicate a capability of supporting beam management based on AI/ML. Alternatively or in addition, the capabilities can indicate a capability of supporting beam prediction in spatial domain based on AI/ML. Additionally, the capabilities may indicate that the terminal device 110-1 supports a capability of supporting online training. For example, fine-tuning can be applied for the online training. It should be noted that other proper methods can also be applied for the online training. The capabilities can also indicate an index of the AI/ML model which the terminal device 110-1 supports. In some other embodiments, the capabilities can indicate a first time delay which is the minimum time required for detecting a failure in the AI/ML model at the terminal device 110-1 side. In this way, the network device 120 can configure the corresponding AI/ML mode and related enable parameters for the terminal device 110-1.

In other embodiments, the capabilities can indicate a second time delay which is the minimum time required for online training of the AI/ML mode at the terminal device 110-1 side. In this way, it can facilitate the integration analysis of the AI/ML model.

The network device 120 transmits 2020 one or more configurations associated with the AI/ML model to the terminal device 110-1. The configuration(s) can be transmitted via higher layer signaling. For example, the configuration(s) can be transmitted via RRC signaling.

In some embodiments, the one or more configuration can comprise a first configuration. In this case, the first configuration can indicate the index of the AI/ML model. In addition, the first configuration can indicate a first type of parameters of the AI/ML model. In this case, the first type of parameters can comprise a structure parameter of the AI/ML mode. For example, the structure parameters can indicate a deep neural network (DNN) of the AI/ML mode. Alternatively, the structure parameters can indicate a convolutional neural network (CNN) of the AI/ML mode. The structure parameters may also indicate the number of layers of the AI/ML model. The structure parameters may indicate the type of layer of the AI/ML model. Additionally, the structure parameters can indicate the number of neurons of the AI/ML model. In some other embodiments, the first type of parameters can comprise a factor of the AI/ML model. For example, the factor can be a weight factor. Alternatively or in addition, the factor can be a bias factor. Additionally or alternatively, the first configuration can indicate a first type of parameters. In other words, the terminal device 110-1 can be configured with the AI/ML model and corresponding first type of parameters. The first type of parameters can comprise a data format of an input of the AI/ML model. For example, the data format of the input may comprise the number of rows and columns of the input data. In addition, the data format of the input may comprise a unit of the input data. The data format of the input may also comprise interpretation of the input data.

In addition, the first type of parameters can comprise a data format of an output of the AI/ML model. Similarly, the data format of the output may comprise the number of rows and columns of the output data. In addition, the data format of the output may comprise a unit of the output data. The data format of the output may also comprise interpretation of the output data.

In some embodiments, the first type of parameters can comprise a pre-process parameter of the AI/ML model. The first type of parameters may also comprise a post-process parameter of the AI/ML model. For example, the first type of parameters may comprise standardization coefficient(s). The term “standardization coefficient” can refer to performing normalization operation for input data to flatten input/output data to the same distribution and accelerate training network. For example, for the maximum value-based normalization, all input data can be divided by a maximum value, which is the standardization coefficient.

In addition, the first configuration may also comprise a first enable parameter. The first enable can be used to enable the terminal device 110-1 to detect the failure in the AI/ML model. For example, if the first configuration does not comprise the first enable parameter, the terminal device 110-1 may not perform the detection of the failure in the AI/ML model. Alternatively, if the first enable parameter is set to disable (for example, set to “0”), the terminal device 110-1 may not perform the detection of the failure in the AI/ML model. In other embodiments, if the first enable parameter is set to enable (for example, set to “1”), the terminal device 110-1 may perform the detection of the failure in the AI/ML model. In some embodiments, the first enable parameter can be transmitted in the configuration of the CSI report. Alternatively, the first enable parameter can be transmitted via other higher layer signaling. In this way, the terminal device can determine the AI/ML model and executable behavior.

In other embodiments, the first configuration may comprise a third enable parameter. The third enable parameter can be used to enable the terminal device 110-1 to perform online training the AI/ML model. For example, if the first configuration does not comprise the third enable parameter, the terminal device 110-1 may not perform the online training of the AI/ML model. Alternatively, if the third enable parameter is set to disable (for example, set to “0”), the terminal device 110-1 may not perform the online training of the AI/ML model. In other embodiments, if the third enable parameter is set to enable (for example, set to “1”), the terminal device 110-1 may perform the online training of the AI/ML model. In this way, the terminal device is able to perform the online training of the AI/ML model.

The network device 120 transmits 2030 an indication triggering a report for obtaining information associated with the AI/ML model. In some embodiments, the CSI report can be a periodic CSI report which can be configured by RRC signaling. Alternatively, the CSI report can be a semi-persistent CSI report. In this case, such CSI report can be activated by a medium access control control element (MAC CE) from the network device 120. In other embodiments, the CSI report can be an aperiodic CSI report or a SP-CSI report. In this case, the CSI report can be triggered by downlink control information (DCI) from the network device 120.

In some embodiments, the network device 120 may transmit a configuration of the CSI report. For example, the configuration of the CSI report can be transmitted via the higher layer configuration of CSI-ReportConfig. The configuration of the CSI report may indicate that the CSI report is associated with one or more CSI-RS or SSB resource sets. In some embodiments, the CSI-RS resource set can be periodic. Alternatively, the CSI-RS resource set can be semi-persistent. In other embodiments, the CSI-RS resource set can be aperiodic. In some embodiments, each CSI-RS resource in the CSI-RS resource set can correspond to a beam. The configuration of the CSI report may also indicate the index of the AI/ML model, which means that the CSI report is associated with the AI/ML model. In this way, the terminal device can know which AI/ML model the CSI report is applied to.

The network device 120 may transmit 2040 a set of reference signals to the terminal device 110-1. The network device 120 can transmit the set of reference signals based on the CSI-RS resource set.

The terminal device 110-1 can measure 2050 the set of reference signals. The terminal device 110-1 may measure reference signal received power (RSRP) on the set of reference signals. For example, the terminal device 110-1 may measure CSI-RS resource indicator (CRI)-RSRP based on the set of reference signals. Alternatively, the SS/PBCH resource block indicator (SSBRI)-RSRP can be measured. In other embodiments, the terminal device 110-1 can measure the CRI signal-to-interference plus noise ratio (SINR) based on the set of reference signals. Alternatively, the terminal device 110-1 may measure the SSBRI-SINR based on the set of reference signals.

The terminal device 110-1 may transmit 2060 a report to the network device 120. In some embodiments, the report may comprise information associated with the AI/ML model. For example, the report can comprise first information which indicates whether the AI/ML model is failed or not. The first information can be a report quantity. For example, the first information can occupy a bit field in the report. For the purpose of illustrations, if the first information indicates “1”, it means the occurrence of the AI/ML model failure. If the first information indicates “0”, it means no occurrence of the AI/ML model failure. In this way, the terminal device can inform the network device whether the AI/ML model is failed by reporting the first information.

In other embodiments, the report may indicate the measurement result. For example, the report can comprise one of: CRI-RSRP, SSBRI-RSRP, CRI-SINR, or SSBRI-SINR. In some embodiments, the above mentioned one or more configurations can comprise a second enable parameter. The second enable parameter can be used to indicate that the associated report is used to detect the failure in the AI/ML model. In this case, if the failure is detected in the AI/ML model, the terminal device 110-1 may not report any quantity, in other words, the terminal device 110-1 may not transmit the report. The transmission of the report can be skipped. Meanwhile, if there are no other conflicting reports in the time domain, the network device 120 may not receive any reports. In this case, the network device 120 may determine that AI/ML model failure has occurred. Alternatively, if the failure is not detected in the AI/ML model, the terminal device 110-1 may report K (K>0) optimal beams and corresponding beam qualities, i.e., K CRIs and corresponding L1-RSRPs in the report. In this way, because the report is associated with the second enable parameter, although the report quality is set to “CRI-RSRP”, the terminal device also knows that the report is used to detecting the AI/ML model failure.

Alternatively, if the failure is detected in the AUML model, the report can comprise a bit field which indicates a predetermined value. For example, if the failure of the AI/ML model occurs, the value of bit field corresponding to CRI and/or the L1-RSRP field in the report can be set to all “1.”

In some embodiments, the above mentioned one or more configurations can comprise a second configuration. The second configuration may indicate a time offset. In this case, the terminal device 110-1 may transmit the report on a slot which is determined based on the time offset. In some embodiments, the time offset may depend on a first time delay which is minimum time required for detecting a failure in the AI/ML model at the terminal device 110-1. Alternatively, the time offset may depend on a second time delay which is minimum time required for the online training of the AI/ML model at the terminal device 110-1. The time offset can indicate on which slot the terminal device 110-1 transfer the report quantity. In some embodiments, the time offset can refer to a time offset by the high layer configuration of CSI-ReportPeriodicityAndOffset or reportSlotOffsetList. Alternatively, the time offset can be configured via a RRC configuration independently high of layer configuration of CSI-ReportPeriodicity AndOffset or reportSlotOffsetList. In this case, if first time offset is configured in the RRC configuration, the terminal device 110-1 may ignore the value provided by the high layer configuration of CSI-ReportPeriodicityAndOffset or reportSlotOffsetList. In this case, the terminal device can know when to perform the reporting.

The terminal device 110-1 may determine that the failure occurs on the AIML model if at least one condition is fulfilled. For example, if a first target beam determined based on the AI/ML model is different from a second target beam determined based on the measurement of the set of reference signals, the terminal device 110-1 may determine that the failure occurs on the AI/ML model. Alternatively, if a difference between a first quantity of the first target beam and a second quantity of the second target beam exceeds a first threshold value, the terminal device 110-1 may determine that the failure occurs on the AI/ML model. In other embodiments, the number of the condition being fulfilled exceeds a second threshold value, the terminal device 110-1 may determine that the failure occurs on the AI/ML model. For example, the second threshold value may be configured via RRC signaling. In this case, the terminal device and the network device know under what conditions the AI/ML model will occur.

In some embodiments, the terminal device 110-1 may transmit a plurality of reports. In this case, each of the plurality of reports can indicate a corresponding priority. For example, if other uplink information (for example, another report) needs to be transmitted, the terminal device 110-1 may determine whether the other uplink information collides with the report. If the other uplink information collides with the report, the terminal device 110-1 may compare a first priority of the report and a second priority of the other uplink information. In this case, if the first priority is higher than the second priority, the terminal device 110-1 may transmit the report to the network device. The value of the first priority can be determined from a set of values. The value of the second priority can also be determined from the set of values. The set of values can comprise 0, 1, and 2. It should be noted that the set of values can also comprise other values. In this way, when multiple reports carrying different contents collide, the terminal device knows which CSI report to send first.

Alternatively, the network device 120 can determine whether the failure occurs on the AI/ML model. In this case, a new report quantity can be introduced, for example, the second information. The second information may comprise inference information and actual information. In this case, the inference information comprises at least one of an inference beam determined based on the AI/ML model or a beam quality corresponding to the inference beam. In addition, the actual information comprises at least one of an actual beam determined based on the measurement of a set of reference signals associated with the report or a beam quality corresponding to the actual beam. In some embodiments, the beam quality can be RSRP. Alternatively, the beam quality can be SINR. In some embodiments, the beam quality can be defined by a 7-bit value. The beam quality can be in a range from −140 dBm to −44 dBm with 1 dB step size. In some embodiments, the bit field corresponding to the inference beam and the beam quality corresponding to the inference beam is in front the bit field corresponding to the actual beam and the beam quality corresponding to the actual beam. Alternatively, the bit field corresponding to the inference beam and the beam quality corresponding to the inference beam is back of the bit field corresponding to the actual beam and the beam quality corresponding to the actual beam.

In some embodiments, the report may be associated with third information. In this case, the third information may comprise a second type of parameters of the trained AI/ML model which is updated based on the AI/ML model. For example, the third information may comprise mainly the amount of change of the trained AI/ML model compared with the AI/ML model, e.g., weight factor and bias factor. In this way, it can facilitate the integration analysis of the model in the network device side. Alternatively, the terminal device 110-1 may not report the trained AI/ML model. In this case, the terminal device 110-1 may only need to report K optimal beams.

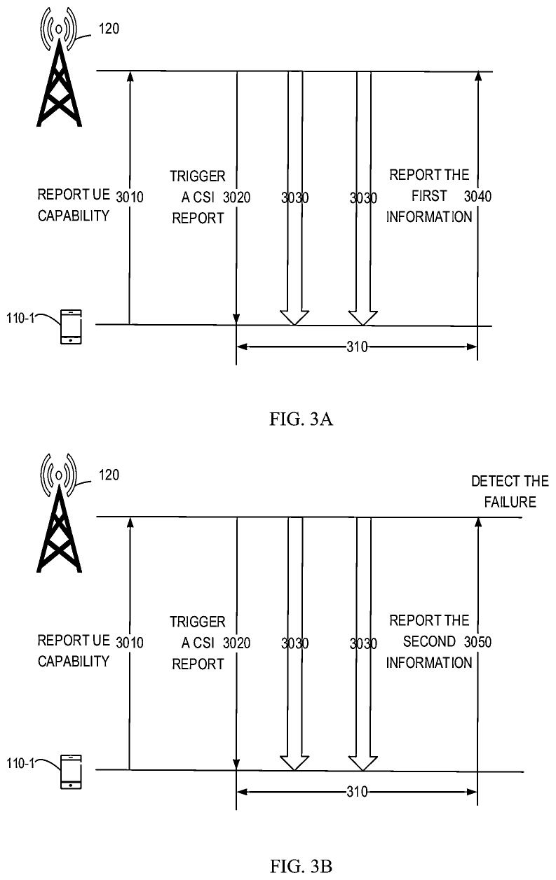

Example embodiments are described with reference to FIGS. 3A-5 in details. FIG. 3A shows the process where the failure in the AI/ML model is detected by the terminal device 110-1.

The terminal device 110-1 reports 3010 one or more capabilities of the terminal device 110-1 to the network device 120. The one or more capabilities at least indicate that the terminal device 110-1 supports an AI/ML model.

In some embodiments, the capabilities can indicate a capability of supporting AI/ML. In some embodiments, the capabilities can indicate a capability of supporting beam management based on AI/ML. Alternatively or in addition, the capabilities can indicate a capability of supporting beam prediction in spatial domain based on AIML. Additionally, the capabilities may indicate that the terminal device 110-1 supports a capability of supporting online training. For example, fine-tuning can be applied for the online training. It should be noted that other proper methods can also be applied for the online training. The capabilities can also indicate an index of the AI/ML model which the terminal device 110-1 supports. In some other embodiments, the capabilities can indicate a first time delay which is the minimum time required for detecting a failure in the AI/ML model at the terminal device 110-1 side. In this way, the network device 120 can configure the corresponding AI/ML mode and related enable parameters for the terminal device 110-1.

The terminal device 110-1 can be configured with an AI/ML model and a first enable parameter by high layer configurations (e.g., RRC signaling). The AI/ML model may include: an index (ID) of the AI/ML model, structure parameters (e.g., DNN, CNN, the number of layers, type of layer, the number of neurons), factor (e.g., weight factor, bias factor). The first enable parameter is used to enable the terminal device 110-1 to perform the function of detecting the AI/ML model failure. If the terminal device 110-1 is not configured with the first enable parameter or the first enable parameter that is set to disable, the terminal device 110-1 does not expect to perform detecting the AI/ML model failure.

In some embodiments, the terminal device 110-1 may also be configured with a first enable parameter and a first type of parameters. The first type of parameters may comprise data format of input/output of the AI/ML model, pre/post-process parameter (e.g., standardization coefficient). The AI/ML model can be associated with the first type of parameters. For example, the terminal device 110-1 is configured with an AI/ML model and corresponding first type of parameters.

The network device 120 triggers 3020 a CSI report for the terminal device 110-1. The CSI report can be a periodic CSI report configured by RRC, or semi-persistent CSI report activated by MAC-CE, or aperiodic CSI report or SP-CSI report triggered by a DCI. And the CSI report may refer to the high layer configuration of CSI-ReportConfig.

The CSI report is associated with one or more CSI-RS (or SSB) resource set 3030 with repetition being off. Type of the CSI-RS resource set can be periodic, semi-persistent, or aperiodic. Each CSI-RS resource in the CSI-RS resource set corresponds to a beam. At the terminal device side, these CSI-RS resources are used to collect input/output data for detecting the AI/ML model failure. For example, each CSI-RS resource can correspond to beams 131-1, 132-1, 133-1 and 134-1, respectively.

The CSI report may be associated with AI/ML model. For example, the index of the AI/ML model can be configured in high layer configuration of the CSI report (e.g., CSI-ReportConfig).

The terminal device 110-1 reports 3040 first information. The first information can be a newly introduced report quantity, i.e., content(s) to be reported by the terminal device 110-1. Specifically, the first information may be used to indicate whether the AI/ML model associated with the CSI report is failure or not. And the first information report occupies 1-bit field: “1” refers to “occurrence of the AI/ML model failure”, “0” refers to “no occurrence of the AI/ML model failure”.

Alternatively, the report quantity associated with the CSI report can be set to “CRI-RSRP” (or “SSBRI-RSRP”, “CRI-SINR”, “SSBRI-SINR”), at the same time, the CSI report may be associated with a second enable parameter. In this case, the second enable parameter can be used to indicate that an associated CSI report is used to detecting the AI/ML model failure. In particular, if the AI/ML model failure occurs, the terminal device 110-1 does not report any quantity, in other words, the terminal device 110-1 does not transfer the CSI report to the network device 120. At this time, if there are no other conflicting CSI reports in the time domain, the network device 120 will not receive any CSI report, and then it will be considered that AI/ML model failure has occurred. Otherwise (i.e., if the AI/ML model failure does not occur), the terminal device 110-1 can report K (K>0) optimal beams and corresponding beam qualities, i.e., K CRIs and corresponding to L1-RSRPs. Optionally, if the AI/ML model failure occurs, the value of bit field corresponding to CRI or (and) L1-RSRP reported the UE are “1111 . . . ” (i.e., all “1”).

In some embodiments, the CSI report may be associated with a first time offset 310. The first time offset 310 can be used to indicate on which slot the terminal device 110-1 transfers the report quantity. Specifically, the first time offset 310 may refer to a time offset by the high layer configuration of CSI-ReportPeriodicity AndOffset or reportSlotOffsetList. Further, the value of the first time offset 310 depends on the first time delay reported. Optionally, the first time offset 310 may be configured a RRC independently of high layer configuration of CSI-ReportPeriodicityAndOffset or reportSlotOffsetList. Further, if the first time offset 310 is configured (or the field of the first time offset is present), the terminal device 110-1 shall ignore the value provided by the high layer configuration of CSI-ReportPeriodicity AndOffset or reportSlotOffsetList.

The terminal device 110-1 can determine the availability of the AI/ML model according to the following criterions. In this case, the terminal device 110-1 may report the first information which indicates whether the AI/ML model failure occurs.

Criterion-1: the inferenced optimal beam based on AI/ML model is inconsistent with the actual optimal beam not based on AI/ML model. Specifically, “the inferenced optimal beam” means that “CRI corresponding to the inferenced CSI-RS resource having the largest quantities (e.g., L1-RSRP, L1-SINR)”, “the actual optimal beam” means that CRI corresponding to the actual CSI-RS resource having the largest quantities. For example, the inferenced optimal beam based on AI/ML model may be beam 131-1 and the actual optimal beam not based on AI/ML model may be beam 133-1. Criterion-2: the difference between quantities (e.g., L1-RSRP. L1-SINR) corresponding to the inferenced optimal beam and quantities corresponding to the actual optimal beam is bigger than a first threshold (configured by RRC). For example, the difference between the L1-RSRP of beam 131-1 and the L1-RSRP of beam 133-1 may exceed the first threshold. Specifically, if the criterion-1 or criterion-2 is met, the terminal device 110-1 can determine that the AI/ML model failure occurs. Further, the terminal device 110-1 can be configured with a second threshold (configured by RRC). Assuming that value of the second threshold is 3, if the criterion-1 or criterion-2 is met for more than 3 consecutive times, the AI/ML model is not available. Otherwise, the AI/ML model is available.

When multiple CSI reports are triggered by the network device 120 at the same time, these CSI reports may collide. For example, two CSI reports can be regarded as collision if the time occupancy of the physical channels scheduled to carry the CSI reports overlap in at least one OFDM symbol and are transmitted on the same carrier. In this case, priorities for CSI report should be specified. For example, if the CSI report associated with the first information collides with the other CSI report for beam (e.g., CRI-RSRP) or for CSI acquisition (e.g., CRI-RI-PMI-CQI) and the time domain types corresponding to these CSI reports are the same (e.g., aperiodic), the terminal device 110-1 does preferentially transmits the CSI report associated with (e.g., carrying) the first information. At this time, k equals to 0 is for CSI report carrying the first information, k=1,2 are for CSI report carrying L1-RSRP or L1-SINR and CSI report not carrying L1-RSRP, L1-SINR or first information respectively, where “k” is a parameter used to calculate the priority value of the CSI report. Optionally, the value of k corresponding to the CSI report carrying the first information, the CSI report carrying L1-RSRP or L1-SINR and the CSI report not carrying L1-RSRP, L1-SINR or the first information also are [1,0,2] or [2,0,1] respectively. That is, the CSI report carrying the first information has intermediate or the lowest priority.

FIG. 3B shows the process where the failure in the AI/ML modle is detected by the network device 120.

As shown in FIG. 3B, the terminal device 110-1 reports 3050 second information. In this case, in some embodiments, the second information can be a new report quantity. The second information may comprise the inferenced optimal beam (for example, the beam 131-1) and the actual optimal beam (for example, the beam 133-1) and corresponding beam qualities, i.e., CRI corresponding to the inferenced CSI-RS resource having the largest quantities (e.g., L1-RSRP) and corresponding quantities, and CRI corresponding to the actual CSI-RS resource having the largest quantities. In some embodiments, the reported L1-RSRP value corresponding to the inferenced and actual optimal beam may be defined by a 7-bit value in the range [−140, −44] dBm with 1 dB step size. Further, the inferenced (or actual) optimal beam and corresponding L1-RSRP can occupy the front bit field, the other one occupy the remaining bit field. Optionally, the report quantity also can be set to “CRI-RSRP” (or “SSBRI-RSRP”, “CRI-SINR”, “SSBRI-SINR”), at the same time, if the CSI report associated with the second enable parameter, the terminal device 110-1 does not expect to report K optimal beams (reuse R15/16), and the terminal device 110-1 shall report the inferenced optimal beam and the actual optimal beam and corresponding beam qualities.

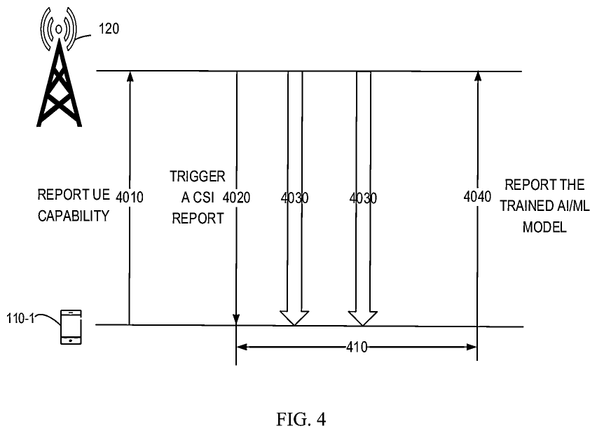

FIG. 4 shows the process where the online training of the AI/ML model is performed by the terminal device 110-1.

The terminal device 110-1 reports 4010 one or more capabilities of the terminal device 110-1 to the network device 120. The one or more capabilities at least indicate that the terminal device 110-1 supports AI/ML. In some embodiments, the capabilities can indicate a second time delay which is the minimum time required for online training at the terminal device 110-1 side. In this way, it can facilitate the integration analysis of the AI/ML model.

The terminal device 110-1 can be configured with an AI/ML model and a third enable parameter. The third enable parameter may be used to enable the terminal device 110-1 to perform the function of online training the AI/ML model. In this case, if the terminal device 110-1 is not configured with the third enable parameter or the third enable parameter that is set to disable, the terminal device 110-1 does not expect to perform online training for the AI/ML model.

The network device 120 triggers 4020 a CSI report for the terminal device 110-1. The CSI report can be a periodic CSI report configured by RRC, or semi-persistent CSI report activated by MAC-CE, or aperiodic CSI report or SP-CSI report triggered by a DCI. And the CSI report may refer to the high layer configuration of CSI-ReportConfig.

In some embodiments, the CSI report may be associated with CSI-RS resource sets 4030. Compared with failure detection, the CSI report may be associated with more CSI-RS resource sets, since more data is required for training of the AI/ML model.

The terminal device 110-1 reports 4040 the trained AI/ML model. For example, the CSI report may be associated with third information. In this case, the third information can be a newly introduced report quantity. Specifically, the third information can comprise the trained AI/ML model related parameters, e.g., mainly the amount of change of the trained AI/ML model compared with the AI/ML model, e.g., weight factor and bias factor. Optionally, the terminal device 110-1 also cannot report the trained AI/ML model. For example, the report quantity may be set to “CRI-RSRP”, the terminal device 110-1 only need to report K optimal beams.

In some embodiments, the CSI report may be associated with a second time offset 410. The second time offset 410 may be used to indicate on which slot the terminal device 110-1 transfers the report quantity. Specifically, the second time offset 410 may refer to a time offset by the high layer configuration of CSI-ReportPeriodicity AndOffset or reportSlotOffsetList. Further, the value of the second time offset 410 depends on the second time delay reported. Optionally, the second time offset 410 may be configured a RRC independently of high layer configuration of CSI-ReportPeriodicityAndOffset or reportSlotOffsetList. Further, if the second time offset 410 is configured (or the field of the second time offset is present), the terminal device 110-1 shall ignore the value provided by the high layer configuration of CSI-ReportPeriodicity AndOffset or reportSlotOffsetList.

In some embodiment, priorities for CSI report should be specified. In some embodiments, the first information and the third information may coexist. The value of k corresponding to the CSI report carrying the first information, the CSI report carrying the third information, the CSI report carrying L1-RSRP or L1-SINR and the CSI report not carrying L1-RSRP, L1-SINR, the first information or the third information are [0,1,2,3], [2,3,0,1], [0,2,1,3] or [0,3,1,2].

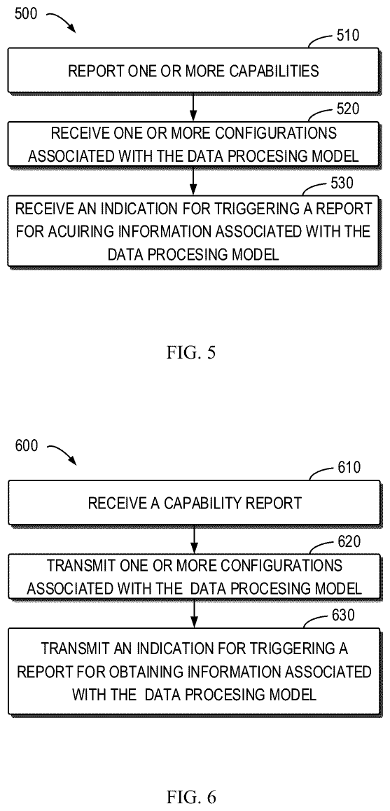

FIG. 5 shows a flowchart of an example method 500 in accordance with an embodiment of the present disclosure. The method 500 can be implemented at any suitable devices. Only for the purpose of illustrations, the method 500 can be implemented at a terminal device 110-1 as shown in FIG. 1.

At block 510, the terminal device 110-1 reports one or more capabilities of the terminal device 110-1 to the network device 120. The one or more capabilities at least indicate that the terminal device 110-1 supports an AI/ML model.

In some embodiments, the capabilities can indicate a capability of supporting AI/ML. In some embodiments, the capabilities can indicate a capability of supporting beam management based on AI/ML. Alternatively or in addition, the capabilities can indicate a capability of supporting beam prediction in spatial domain based on AI/ML. Additionally, the capabilities may indicate that the terminal device 110-1 supports a capability of supporting online training. For example, fine-tuning can be applied for the online training. It should be noted that other proper methods can also be applied for the online training. The capabilities can also indicate an index of the AI/ML model which the terminal device 110-1 supports. In some other embodiments, the capabilities can indicate a first time delay which is the minimum time required for detecting a failure in the AI/ML model at the terminal device 110-1 side. In this way, the network device 120 can configure the corresponding AI/ML mode and related enable parameters for the terminal device 110-1.

In other embodiments, the capabilities can indicate a second time delay which is the minimum time required for online training of the AI/ML mode at the terminal device 110-1 side. In this way, it can facilitate the integration analysis of the AI/ML model.

At block 520, the terminal device 110-1 receives one or more configurations of the data processing model from the network device 120. The one or more configurations can be transmitted via higher layer signaling. For example, the one or more configurations can be transmitted via RRC signaling.

In some embodiments, the one or more configuration can comprise a first configuration. In this case, the first configuration can indicate the index of the AI/ML model. In addition, the first configuration can indicate a first type of parameters of the AI/ML model. In this case, the first type of parameters can comprise a structure parameter of the AI/ML mode. For example, the structure parameters can indicate a deep neural network (DNN) of the AI/ML mode. Alternatively, the structure parameters can indicate a convolutional neural network (CNN) of the AI/ML mode. The structure parameters may also indicate the number of layers of the AI/ML model. The structure parameters may indicate the type of layer of the AI/ML model. Additionally, the structure parameters can indicate the number of neurons of the AI/ML model. In some other embodiments, the first configuration can indicate a factor of the AI/ML model. For example, the factor can be a weight factor. Alternatively or in addition, the factor can be a bias factor.

Additionally or alternatively, the first configuration can indicate a first type of parameters. In other words, the terminal device 110-1 can be configured with the AI/ML model and corresponding first type of parameters. The first type of parameters can comprise a data format of an input of the AI/ML model. For example, the data format of the input may comprise the number of rows and columns of the input data. In addition, the data format of the input may comprise a unit of the input data. The data format of the input may also comprise interpretation of the input data.

In addition, the first type of parameters can comprise a data format of an output of the AI/ML model. Similarly, the data format of the output may comprise the number of rows and columns of the output data. In addition, the data format of the output may comprise a unit of the output data. The data format of the output may also comprise interpretation of the output data.

In some embodiments, the first type of parameters can comprise a pre-process parameter of the AI/ML model. The first type of parameters may also comprise a post-process parameter of the AI/ML model. For example, the first type of parameters may comprise standardization coefficient(s). The term “standardization coefficient” can refer to performing normalization operation for input data to flatten input/output data to the same distribution and accelerate training network. For example, for the maximum value-based normalization, all input data can be divided by a maximum value, which is the standardization coefficient.

In addition, the first configuration may also comprise a first enable parameter. The first enable can be used to enable the terminal device 110-1 to detect the failure in the AI/ML model. For example, if the first configuration does not comprise the first enable parameter, the terminal device 110-1 may not perform the detection of the failure in the AI/ML model. Alternatively, if the first enable parameter is set to disable (for example, set to “0”), the terminal device 110-1 may not perform the detection of the failure in the AI/ML model. In other embodiments, if the first enable parameter is set to enable (for example, set to “1”), the terminal device 110-1 may perform the detection of the failure in the AI/ML model. In this way, the terminal device can determine the AI/ML model and executable behavior.

In other embodiments, the first configuration may comprise a third enable parameter. The third enable parameter can be used to enable the terminal device 110-1 to perform online training the AI/ML model. For example, if the first configuration does not comprise the third enable parameter, the terminal device 110-1 may not perform the online training of the AI/ML model. Alternatively, if the third enable parameter is set to disable (for example, set to “0”), the terminal device 110-1 may not perform the online training of the AI/ML model. In other embodiments, if the third enable parameter is set to enable (for example, set to “1”), the terminal device 110-1 may perform the online training of the AI/ML model. In this way, the terminal device is able to perform the online training of the AI/ML model.

At block 530, the terminal device 110-1 receives an indication triggering a report for obtaining information associated with the data processing model. In some embodiments, the CSI report can be a periodic CSI report which can be configured by RRC signaling. Alternatively, the CSI report can be a semi-persistent CSI report. In this case, such CSI report can be activated by a medium access control control element (MAC CE) from the network device 120. In other embodiments, the CSI report can be an aperiodic CSI report or a SP-CSI report. In this case, the CSI report can be triggered by downlink control information (DCI) from the network device 120.

In some embodiments, the terminal device 110-1 may receive a configuration of the CSI report. For example, the configuration of the CSI report can be transmitted via the higher layer configuration of CSI-ReportConfig. The configuration of the CSI report may indicate that the CSI report is associated with one or more CSI-RS or SSB resource sets. In some embodiments, the CSI-RS resource set can be periodic. Alternatively, the CSI-RS resource set can be semi-persistent. In other embodiments, the CSI-RS resource set can be aperiodic. In some embodiments, each CSI-RS resource in the CSI-RS resource set can correspond to a beam. The configuration of the CSI report may also indicate the index of the AI/ML model, which means that the CSI report is associated with the AI/ML model. In this way, the terminal device can know which AI/ML model the CSI report is applied to.

In some embodiments, the terminal device 110-1 may receive a set of reference signals to the terminal device 110-1. The network device 120 can transmit the set of reference signals based on the CSI-RS resource set.

In some embodiments, the terminal device 110-1 can measure the set of reference signals. The terminal device 110-1 may measure RSRP on the set of reference signals. For example, the terminal device 110-1 may measure CRI-RSRP based on the set of reference signals. Alternatively, the SSBRI-RSRP can be measured. In other embodiments, the terminal device 110-1 can measure the CRI SINR based on the set of reference signals. Alternatively, the terminal device 110-1 may measure the SSBRI-SINR based on the set of reference signals.

The terminal device 110-1 may transmit a report to the network device 120. In some embodiments, the report may comprise information associated with the AI/ML model. For example, the report can comprise first information which indicates whether the AI/ML model is failed or not. The first information can be a report quantity. For example, the first information can occupy a bit field in the report. For the purpose of illustrations, if the first information indicates “1”, it means the occurrence of the AI/ML model failure. If the first information indicates “0”, it means no occurrence of the AI/ML model failure. In this way, the terminal device can inform the network device whether the AI/ML model is failed by reporting the first information.

In other embodiments, the report may indicate the measurement result. For example, the report can comprise one of: CRI-RSRP, SSBRI-RSRP, CRI-SINR, or SSBRI-SINR. In some embodiments, the above mentioned one or more configurations can comprise a second enable parameter. The second enable parameter can be used to indicate that the associated report is used to detect the failure in the AI/ML model. In this case, if the failure is detected in the AI/ML model, the terminal device 110-1 may not report any quantity, in other words, the terminal device 110-1 may not transmit the report. The transmission of the report can be skipped. Meanwhile, if there are no other conflicting reports in the time domain, the network device 120 may not receive CSI reports. In this case, the network device 120 may determine that AI/ML model failure has occurred. Alternatively, if the failure is not detected in the AI/ML model, the terminal device 110-1 may report K (K>0) optimal beams and corresponding beam qualities, i.e., K CRIs and corresponding L1-RSRPs in the report. In this way, because the report is associated with the second enable parameter, although the report quality is set to “CRI-RSRP”, the terminal device also knows that the CSI report is used to detecting the AI/ML model failure.

Alternatively, if the failure is detected in the AI/ML model, the report can comprise a bit field which indicates a predetermined value. For example, if the failure of the AI/ML model occurs, the value of bit field corresponding to CRI and/or the L1-RSRP field in the report can be set to all “1.”

In some embodiments, the above mentioned one or more configurations can comprise a second configuration. The second configuration may indicate a time offset. In this case, the terminal device 110-1 may transmit the report on a slot which is determined based on the time offset. In some embodiments, the time offset may depend on a first time delay which is minimum time required for detecting a failure in the AI/ML model at the terminal device 110-1. Alternatively, the time offset may depend on a second time delay which is minimum time required for the online training of the AI/ML model at the terminal device 110-1. The time offset can indicate on which slot the terminal device 110-1 transfer the report quantity. In some embodiments, the time offset can refer to a time offset by the high layer configuration of CSI-ReportPeriodicityAndOffset or reportSlotOffsetList. Alternatively, the time offset can be configured via a RRC configuration independently high of layer configuration of CSI-ReportPeriodicity AndOffset or reportSlotOffsetList. In this case, if first time offset is configured in the RRC configuration, the terminal device 110-1 may ignore the value provided by the high layer configuration of CSI-ReportPeriodicity AndOffset or reportSlotOffsetList. In this case, the terminal device can know when to perform the reporting.

The terminal device 110-1 may determine that the failure occurs on the AI/ML model if at least one condition is fulfilled. For example, if a first target beam determined based on the AI/ML model is different from a second target beam determined based on the measurement of the set of reference signals, the terminal device 110-1 may determine that the failure occurs on the AI/ML model. Alternatively, if a difference between a first quantity of the first target beam and a second quantity of the second target beam exceeds a first threshold value, the terminal device 110-1 may determine that the failure occurs on the AI/ML model. In other embodiments, the number of the condition being fulfilled exceeds a second threshold value, the terminal device 110-1 may determine that the failure occurs on the AI/ML model. For example, the second threshold value may be configured via RRC signaling. In this case, the terminal device and the network device know under what conditions the AI/ML model will occur.

In some embodiments, the terminal device 110-1 may transmit a plurality of reports. In this case, each of the plurality of reports can indicate a corresponding priority. For example, if other uplink information (for example, another report) needs to be transmitted, the terminal device 110-1 may determine whether the other uplink information collides with the report. If the other uplink information collides with the report, the terminal device 110-1 may compare a first priority of the report and a second priority of the other uplink information. In this case, if the first priority is higher than the second priority, the terminal device 110-1 may transmit the report to the network device. The value of the first priority can be determined from a set of values. The value of the second priority can also be determined from the set of values. The set of values can comprise 0, 1, and 2. It should be noted that the set of values can also comprise other values. In this way, when multiple reports carrying different contents collide, the terminal device knows which CSI report to send first.

Alternatively, the network device 120 can determine whether the failure occurs on the AI/ML model. The second information may comprise inference information and actual information. In this case, the inference information comprises at least one of an inference beam determined based on the AI/ML model or a beam quality corresponding to the inference beam. In addition, the actual information comprises at least one of an actual beam determined based on the measurement of a set of reference signals associated with the report or a beam quality corresponding to the actual beam. In some embodiments, the beam quality can be RSRP. Alternatively, the beam quality can be SINR. In some embodiments, the beam quality can be defined by a 7-bit value. The beam quality can be from −140 dBm to −44 dBm with 1 dB step size. In some embodiments, the bit field corresponding to the inference beam and the beam quality corresponding to the inference beam is in front the bit field corresponding to the actual beam and the beam quality corresponding to the actual beam. Alternatively, the bit field corresponding to the inference beam and the beam quality corresponding to the inference beam is back of the bit field corresponding to the actual beam and the beam quality corresponding to the actual beam.

In some embodiments, the report may be associated with third information. In this case, the third information may comprise a second type of parameters of the trained AI/ML model which is updated based on the AI/ML model. For example, the third information may comprise mainly the amount of change of the trained AI/ML model compared with the AI/ML model, e.g., weight factor and bias factor. In this way, it can facilitate the integration analysis of the model in the network device side. Alternatively, the terminal device 110-1 may not report the trained AI/ML model. In this case, the terminal device 110-1 may only need to report K optimal beams.

FIG. 6 shows a flowchart of an example method 600 in accordance with an embodiment of the present disclosure. The method 600 can be implemented at any suitable devices. Only for the purpose of illustrations, the method 600 can be implemented at a network device 120 as shown in FIG. 1.

At block 610, the network device 120 receives a capability report from the terminal device 110-1. The capability report comprises one or more capabilities. The one or more capabilities at least indicate that the terminal device 110-1 supports an AI/ML model.

In some embodiments, the capabilities can indicate a capability of supporting AI/ML. In some embodiments, the capabilities can indicate a capability of supporting beam management based on AI/ML. Alternatively or in addition, the capabilities can indicate a capability of supporting beam prediction in spatial domain based on AI/ML. Additionally, the capabilities may indicate that the terminal device 110-1 supports a capability of supporting online training. For example, fine-tuning can be applied for the online training. It should be noted that other proper methods can also be applied for the online training. The capabilities can also indicate an index of the AI/ML model which the terminal device 110-1 supports. In some other embodiments, the capabilities can indicate a first time delay which is the minimum time required for detecting a failure in the AI/ML model at the terminal device 110-1 side. In this way, the network device 120 can configure the corresponding AI/ML mode and related enable parameters for the terminal device 110-1.

In other embodiments, the capabilities can indicate a second time delay which is the minimum time required for online training of the AI/ML mode at the terminal device 110-1 side. In this way, it can facilitate the integration analysis of the AI/ML model.

At block 620, the network device 120 transmits one or more configurations of the data processing model to the terminal device 110-1. The configuration(s) can be transmitted via higher layer signaling. For example, the configuration(s) can be transmitted via RRC signaling.

In some embodiments, the one or more configuration can comprise a first configuration. In this case, the first configuration can indicate the index of the AI/ML model. In addition, the first configuration can indicate a first type of parameters of the AI/ML model. In this case, the first type of parameters can comprise a structure parameter of the AI/ML mode. For example, the structure parameters can indicate a deep neural network (DNN) of the AI/ML mode. Alternatively, the structure parameters can indicate a convolutional neural network (CNN) of the AI/ML mode. The structure parameters may also indicate the number of layers of the AI/ML model. The structure parameters may indicate the type of layer of the AI/ML model. Additionally, the structure parameters can indicate the number of neurons of the AI/ML model. In some other embodiments, the first type of parameters can comprise a factor of the AI/ML model. For example, the factor can be a weight factor. Alternatively or in addition, the factor can be a bias factor. Additionally or alternatively, the first configuration can indicate a first type of parameters. In other words, the terminal device 110-1 can be configured with the AI/ML model and corresponding first type of parameters. The first type of parameters can comprise a data format of an input of the AI/ML model. For example, the data format of the input may comprise the number of rows and columns of the input data. In addition, the data format of the input may comprise a unit of the input data. The data format of the input may also comprise interpretation of the input data.

In addition, the first type of parameters can comprise a data format of an output of the AI/ML model. Similarly, the data format of the output may comprise the number of rows and columns of the output data. In addition, the data format of the output may comprise a unit of the output data. The data format of the output may also comprise interpretation of the output data.

In some embodiments, the first type of parameters can comprise a pre-process parameter of the AI/ML model. The first type of parameters may also comprise a post-process parameter of the AI/ML model. For example, the first type of parameters may comprise standardization coefficient(s). The term “standardization coefficient” can refer to performing normalization operation for input data to flatten input/output data to the same distribution and accelerate training network. For example, for the maximum value-based normalization, all input data can be divided by a maximum value, which is the standardization coefficient.

In addition, the first configuration may also comprise a first enable parameter. The first enable can be used to enable the terminal device 110-1 to detect the failure in the AI/ML model. For example, if the first configuration does not comprise the first enable parameter, the terminal device 110-1 may not perform the detection of the failure in the AI/ML model. Alternatively, if the first enable parameter is set to disable (for example, set to “0”), the terminal device 110-1 may not perform the detection of the failure in the AI/ML model. In other embodiments, if the first enable parameter is set to enable (for example, set to “1”), the terminal device 110-1 may perform the detection of the failure in the AI/ML model. In this way, the terminal device can determine the AI/ML model and executable behavior.

In other embodiments, the first configuration may comprise a third enable parameter. The third enable parameter can be used to enable the terminal device 110-1 to perform online training the AI/ML model. For example, if the first configuration does not comprise the third enable parameter, the terminal device 110-1 may not perform the online training of the AI/ML model. Alternatively, if the third enable parameter is set to disable (for example, set to “0”), the terminal device 110-1 may not perform the online training of the AI/ML model. In other embodiments, if the third enable parameter is set to enable (for example, set to “1”), the terminal device 110-1 may perform the online training of the AI/ML model. In this way, the terminal device is able to perform the online training of the AI/ML model.

At block 630, the network device 120 transmits an indication triggering a report for obtaining information associated with the data processing model. In some embodiments, the CSI report can be a periodic CSI report which can be configured by RRC signaling. Alternatively, the CSI report can be a semi-persistent CSI report. In this case, such CSI report can be activated by a medium access control control element (MAC CE) from the network device 120. In other embodiments, the CSI report can be an aperiodic CSI report or a SP-CSI report. In this case, the CSI report can be triggered by downlink control information (DCI) from the network device 120.

In some embodiments, the network device 120 may transmit a configuration of the CSI report. For example, the configuration of the CSI report can be transmitted via the higher layer configuration of CSI-ReportConfig. The configuration of the CSI report may indicate that the CSI report is associated with one or more CSI-RS or SSB resource sets. In some embodiments, the CSI-RS resource set can be periodic. Alternatively, the CSI-RS resource set can be semi-persistent. In other embodiments, the CSI-RS resource set can be aperiodic. In some embodiments, each CSI-RS resource in the CSI-RS resource set can correspond to a beam. The configuration of the CSI report may also indicate the index of the AI/ML model, which means that the CSI report is associated with the AI/ML model. In this way, the terminal device can know which AI/ML model the CSI report is applied to.

The network device 120 may transmit a set of reference signals to the terminal device 110-1. The network device 120 can transmit the set of reference signals based on the CSI-RS resource set.

The network device 120 may receive a CSI report from the terminal device 110-1. In some embodiments, the CSI report may comprise first information which indicates whether the AI/ML model is failed or not. The first information can be a report quantity. For example, the first information can occupy a bit field in the CSI report. For the purpose of illustrations, if the first information indicates “1”, it means the occurrence of the AI/ML model failure. If the first information indicates “0”, it means no occurrence of the AI/ML model failure. In this way, the terminal device can inform the network device whether the AI/ML model is failed by reporting the first information.

In other embodiments, the CSI report may indicate the measurement result. For example, the CSI report can comprise one of: CRI-RSRP, SSBRI-RSRP, CRI-SINR, or SSBRI-SINR. The CSI report can be associated with a second enable parameter. The second enable parameter can be used to indicate that the associated CSI report is used to detect the failure in the AI/ML model. In this case, if the failure is detected in the AI/ML model, the terminal device 110-1 may not report any quantity, in other words, the terminal device 110-1 may not transmit the CSI report. The transmission of the CSI report can be skipped. Meanwhile, if there are no other conflicting CSI reports in the time domain, the network device 120 may not receive any CSI reports. In this case, the network device 120 may determine that AI/ML model failure has occurred. Alternatively, if the failure is not detected in the AI/ML model, the terminal device 110-1 may report K (K>0) optimal beams and corresponding beam qualities, i.e., K CRIs and corresponding L1-RSRPs in the CSI report. In this way, because the CSI report is associated with the second enable parameter, although the report quality is set to “CRI-RSRP”, the terminal device also knows that the CSI report is used to detecting the AI/ML model failure.

Alternatively, if the failure is detected in the AI/ML model, the CSI report can comprise a bit field which indicates a predetermined value. For example, if the failure of the AI/ML model occurs, the value of bit field corresponding to CRI and/or the L1-RSRP field in the CSI report can be set to all “1.”

In some embodiments, the network device 120 may transmit a second configuration to the terminal device 110-1. The second configuration may indicate a time offset. In this case, the terminal device 110-1 may transmit the CSI report on a slot which is determined based on the time offset. In some embodiments, the time offset may depend on a first time delay which is minimum time required for detecting a failure in the AI/ML model at the terminal device 110-1. Alternatively, the time offset may depend on a second time delay which is minimum time required for the online training of the AI/ML model at the terminal device 110-1. The time offset can indicate on which slot the terminal device 110-1 transfer the report quantity. In some embodiments, the time offset can refer to a time offset by the high layer configuration of CSI-ReportPeriodicityAndOffset or reportSlotOffsetList. Alternatively, the time offset can be configured via a RRC configuration independently high of layer configuration of CSI-ReportPeriodicityAndOffset or reportSlotOffsetList. In this case, if first time offset is configured in the RRC configuration, the terminal device 110-1 may ignore the value provided by the high layer configuration of CSI-ReportPeriodicityAndOffset or reportSlotOffsetList. In this case, the terminal device can know when to perform the reporting.

In some embodiments, the network device 120 may receive a plurality of CSI reports. In this case, each of the plurality of CSI reports can indicate a corresponding priority. The value of the priorities can be determined from the set of values. The set of values can comprise 0, 1, and 2. It should be noted that the set of values can also comprise other values. In this way, when multiple CSI reports carrying different contents collide, the terminal device knows which CSI report to send first.

Alternatively, the network device 120 can determine whether the failure occurs on the AI/ML model. In this case, a new report quantity can be introduced, for example, the second information. The second information may comprise inference information and actual information. In this case, the inference information comprises at least one of an inference beam determined based on the AI/ML model or a beam quality corresponding to the inference beam. In addition, the actual information comprises at least one of an actual beam determined based on the measurement of a set of reference signals associated with the report or a beam quality corresponding to the actual beam. In some embodiments, the beam quality can be RSRP. Alternatively, the beam quality can be SINR. In some embodiments, the beam quality can be defined by a 7-bit value. The beam quality can be from −140 dBm to −44 dBm with 1 dB step size. In some embodiments, the bit field corresponding to the inference beam and the beam quality corresponding to the inference beam is in front the bit field corresponding to the actual beam and the beam quality corresponding to the actual beam. Alternatively, the bit field corresponding to the inference beam and the beam quality corresponding to the inference beam is back of the bit field corresponding to the actual beam and the beam quality corresponding to the actual beam.

In some embodiments, the report may be associated with third information. In this case, the third information may comprise a second type of parameters of the trained AI/ML model which is updated based on the AI/ML model. For example, the third information may comprise mainly the amount of change of the trained AI/ML model compared with the AI/ML model, e.g., weight factor and bias factor. In this way, it can facilitate the integration analysis of the model in the network device side. Alternatively, the terminal device 110-1 may not report the trained AI/ML model. In this case, the terminal device 110-1 may only need to report K optimal beams.

In some embodiments, a terminal device comprises circuitry configured to report, to a network device, one or more capabilities of the terminal device, wherein the one or more capabilities at least indicate that the terminal device supports a data processing model; receive, from the network device, one or more configurations associated with the data processing model; and receive, from the network device, an indication for triggering a report for acquiring information associated with the data processing model.

In some embodiments, the one or more capabilities further indicate at least one of: a capability of supporting artificial intelligent (AI) or machine learning (ML), a capability of supporting beam management based on AI or ML, a capability of supporting beam prediction in spatial domain based on AI or ML, a capability of supporting online training, an index of the data processing model, a first time delay, wherein the first time delay is minimum time required for detecting a failure in the data processing model at the terminal device, or a second time delay, wherein the second time delay is minimum time required for online training of the data processing model at the terminal device.

In some embodiments, the one or more configurations further indicate at least one of: an index of the data processing model, a first type of parameters of the data processing model, a first enable parameter which is used to enable the terminal device to detect a failure in the data processing model, a second enable parameter which is used to enable the terminal device to perform an online training, or a time offset which is used to indicate the terminal device to transmit the report on a slot which is determined according to the time offset.

In some embodiments, the first type of parameters comprises at least one of: a structure parameter of the data processing model, a weight factor of the data processing model, a bias factor of the data processing model, a data format of an input of the data processing model, a data format of an output of the data processing model, a pre-process parameter of the data processing model, or a post-process parameter of the data processing model.

In some embodiments, the time offset is determined according to a first time delay or a second time delay, and wherein the first time delay is minimum time required for detecting a failure in the data processing model at the terminal device, and the second time delay is minimum time required for online training of the data processing model at the terminal device.

In some embodiments, the terminal device comprises circuitry configured to in accordance with a determination that the terminal device is configured with the time offset, cause a further time offset to be ignored, wherein the further time offset is indicated in a further configuration.

In some embodiments, the information associated with the data processing model comprises one of: a first information indicating whether a failure occurs in the data processing model or not; a second information including an inference information and an actual information; or a third information indicating a second type of parameters of a trained data processing model which is updated based on the data processing model.

In some embodiments, the inference information comprises at least one of an inference beam determined based on the data processing model or a beam quality corresponding to the inference beam, and the actual information comprises at least one of an actual beam determined based on the measurement of a set of reference signals associated with the report or a beam quality corresponding to the actual beam.

In some embodiments, the beam quality comprises at least one of reference signal received power (RSRP) or signal to interference plus noise ratio (SINR).

In some embodiments, the beam quality corresponding to the inference beam is defined by a 7-bit value in a range from −140 to −44 dBm with 1 dB step size, and the beam quality corresponding to the actual beam is defined by a 7-bit value in the range from −140 to −44 dBm with 1 dB step size.

In some embodiments, the bit field corresponding to the inference beam and the beam quality corresponding to the inference beam is in front or back of the bit field corresponding to the actual beam and the beam quality corresponding to the actual beam.

In some embodiments, the second type of parameters comprises at least one of a structure parameter of the trained data processing model, a weight factor of the trained data processing model, or a bias factor of the trained data processing model.

In some embodiments, the terminal device comprises circuitry configured to transmit, to the network device, the report for acquiring the information associated with the data processing model.

In some embodiments, the terminal device comprises circuitry configured to in accordance with a determination that a failure is detected in the data processing model, transmit, to the network device, the report, wherein a bit field corresponding to the report is set to a predetermined number.

In some embodiments, the terminal device comprises circuitry configured to in accordance with a determination that a failure is detected in the data processing model, cause a transmission of the report to be skipped.

In some embodiments, the terminal device comprises circuitry configured to in accordance with a determination that second uplink information needs to be transmitted, determine whether the second uplink information collides with the report; in accordance with a determination that the second uplink information collides with the report, compare a first priority of the report and a second priority of the second uplink information; and in accordance with a determination that the first priority is higher than the second priority, transmit the report to the network device.

In some embodiments, the first priority and the second priority are determined from a set of values, wherein the set of values comprises 0, 1 or 2.

In some embodiments, the terminal device comprises circuitry configured to in accordance with a determination that at least one condition is fulfilled, determine that a failure occurs on the data processing model.

In some embodiments, the at least one condition comprises one of: a first condition where a first target beam determined based on the data processing model is different from a second target beam determined based on the measurement of a set of reference signals associated with the report; a second condition where a difference between a beam quantity of the first target beam and a beam quantity of the second target beam exceeds a first threshold value; or a third condition where the number of the first condition or the second condition being fulfilled exceeds a second threshold value.

In some embodiments, the report comprises at least one of: a periodic channel state information (CSI) report, a semi-persistent CSI report or an aperiodic CSI report.

In some embodiments, a network device comprises circuitry configured to receive, from a terminal device, a capability report comprising one or more capabilities of the terminal device, wherein the one or more capabilities at least indicate that the terminal device supports a data processing model; transmitting, to the terminal device, one or more configurations associated with the data processing model; and transmit, to the terminal device, an indication for triggering a report for acquiring information associated with the data processing model.

In some embodiments, the one or more capabilities further indicate at least one of: a capability of supporting artificial intelligent (AI) or machine learning (ML), a capability of supporting beam management based on AI or ML, a capability of supporting beam prediction in spatial domain based on AI or ML, a capability of supporting online training, an index of the data processing model, a first time delay, wherein the first time delay is minimum time required for detecting a failure in the data processing model at the terminal device, or a second time delay, wherein the second time delay is minimum time required for online training of the data processing model at the terminal device.

In some embodiments, the one or more configurations further indicate at least one of: an index of the data processing model, a first type of parameters of the data processing model, a first enable parameter which is used to enable the terminal device to detect a failure in the data processing model, a second enable parameter which is used to enable the terminal device to perform an online training, or a time offset which is used to indicate the terminal device to transmit the report on a slot which is determined according to the time offset.

In some embodiments, the first type of parameters comprises at least one of: a structure parameter of the data processing model, a weight factor of the data processing model, a bias factor of the data processing model, a data format of an input of the data processing model, a data format of an output of the data processing model, a pre-process parameter of the data processing model, or a post-process parameter of the data processing model.

In some embodiments, the time offset is determined according to a first time delay or a second time delay, and wherein the first time delay is minimum time required for detecting a failure in the data processing model at the terminal device, and the second time delay is minimum time required for online training of the data processing model at the terminal device.

In some embodiments, the report is associated with the one or more configurations associated with the data processing model.

In some embodiments, the information associated with the data processing model comprises one of: a first information indicating whether a failure occurs in the data processing model or not; a second information including an inference information and an actual information; or a third information indicating a second type of parameters of a trained data processing model which is updated based on the data processing model.

In some embodiments, the inference information comprises at least one of an inference beam determined based on the data processing model or a beam quality corresponding to the inference beam, and the actual information comprises at least one of an actual beam determined based on the measurement of a set of reference signals associated with the report or a beam quality corresponding to the actual beam.

In some embodiments, the beam quality comprises at least one of reference signal received power (RSRP) or signal to interference plus noise ratio (SINR).

In some embodiments, the beam quality corresponding to the inference beam is defined by a 7-bit value in a range from −140 to −44 dBm with 1 dB step size, and the beam quality corresponding to the actual beam is defined by a 7-bit value in the range from −140 to −44 dBm with 1 dB step size.

In some embodiments, the bit field corresponding to the inference beam and the beam quality corresponding to the inference beam is in front or back of the bit field corresponding to the actual beam and the beam quality corresponding to the actual beam.

In some embodiments, the second type of parameters comprises at least one of a structure parameter of the trained data processing model, a weight factor of the trained data processing model, or a bias factor of the trained data processing model.

In some embodiments, the network device comprises circuitry configured to receive, from the terminal device, the report for acquiring the information associated with the data processing model.

In some embodiments, the network device comprises circuitry configured to receive in accordance with a determination that a failure is detected in the data processing model, transmit, to the network device, the report, wherein a bit field corresponding to the report is set to a predetermined number.

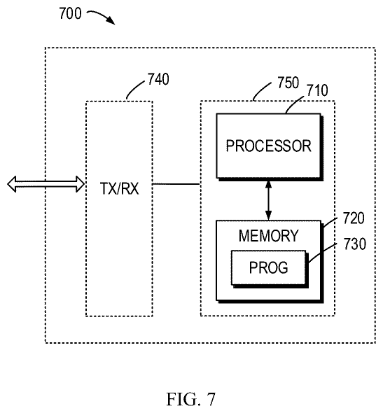

FIG. 7 is a simplified block diagram of a device 700 that is suitable for implementing embodiments of the present disclosure. The device 700 can be considered as a further example implementation of the terminal device 110 as shown in FIG. 1. Accordingly, the device 700 can be implemented at or as at least a part of the terminal device 110. Alternatively, the device 700 can be considered as a further example implementation of the network device 120 as shown in FIG. 1. Accordingly, the device 700 can be implemented at or as at least a part of the network device 120.

As shown, the device 700 includes a processor 710, a memory 720 coupled to the processor 710, a suitable transmitter (TX) and receiver (RX) 740 coupled to the processor 710, and a communication interface coupled to the TX/RX 740. The memory 720 stores at least a part of a program 730. The TX/RX 740 is for bidirectional communications. The TX/RX 740 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the CNB, Un interface for communication between the CNB and a relay node (RN), or Uu interface for communication between the eNB and a terminal device.

The program 730 is assumed to include program instructions that, when executed by the associated processor 710, enable the device 700 to operate in accordance with the embodiments of the present disclosure, as discussed herein with reference to FIGS. 2 to 6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 750 adapted to implement various embodiments of the present disclosure.

The memory 720 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an crasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (Iota) devices, Ultra-reliable and Low Latency Communications (URLLC) devices, Internet of Everything (Iowa) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and Iota applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (Node or NB), an evolved Node (anode or eNB), a next generation Node (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

1. A communication method, comprising:
reporting, at a terminal device and to a network device, one or more capabilities of the terminal device, wherein the one or more capabilities at least indicate that the terminal device supports a data processing model;
receiving, from the network device, one or more configurations associated with the data processing model; and
receiving, from the network device, an indication for triggering a report for acquiring information associated with the data processing model.

2. The method of claim 1, wherein the one or more capabilities further indicate at least one of:
a capability of supporting artificial intelligent (AI) or machine learning (ML),
a capability of supporting beam management based on AI or ML,
a capability of supporting beam prediction in spatial domain based on AI or ML,
a capability of supporting online training,
an index of the data processing model,
a first time delay, wherein the first time delay is minimum time required for detecting a failure in the data processing model at the terminal device, or
a second time delay, wherein the second time delay is minimum time required for online training of the data processing model at the terminal device.

3. The method of claim 1, wherein the one or more configurations further indicate at least one of:
an index of the data processing model,
a first type of parameters of the data processing model,
a first enable parameter which is used to enable the terminal device to detect a failure in the data processing model,
a second enable parameter which is used to enable the terminal device to perform an online training, or
a time offset which is used to indicate the terminal device to transmit the report on a slot which is determined according to the time offset.

4. The method of claim 3, wherein the first type of parameters comprises at least one of:
a structure parameter of the data processing model,
a weight factor of the data processing model,
a bias factor of the data processing model,
a data format of an input of the data processing model,
a data format of an output of the data processing model,
a pre-process parameter of the data processing model, or
a post-process parameter of the data processing model.

5. The method of claim 3, wherein the time offset is determined according to a first time delay or a second time delay, and wherein the first time delay is minimum time required for detecting a failure in the data processing model at the terminal device, and the second time delay is minimum time required for online training of the data processing model at the terminal device.

6. The method of claim 3, further comprising:
in accordance with a determination that the terminal device is configured with the time offset, causing a further time offset to be ignored, wherein the further time offset is indicated in a further configuration.

7. The method of claim 1, wherein the information associated with the data processing model comprises one of:
a first information indicating whether a failure occurs in the data processing model or not;
a second information including an inference information and an actual information; or
a third information indicating a second type of parameters of a trained data processing model which is updated based on the data processing model.

8. The method of claim 7, wherein the inference information comprises at least one of an inference beam determined based on the data processing model or a beam quality corresponding to the inference beam, and
wherein the actual information comprises at least one of an actual beam determined based on the measurement of a set of reference signals associated with the report or a beam quality corresponding to the actual beam.

9. The method of claim 8, wherein at least one of:
the beam quality comprises at least one of reference signal received power (RSRP) or signal to interference plus noise ratio (SINR);
the beam quality corresponding to the inference beam is defined by a 7-bit value in a range from −140 to −44 dBm with 1 dB step size, and the beam quality corresponding to the actual beam is defined by a 7-bit value in the range from −140 to −44 dBm with 1 dB step size; or
the bit field corresponding to the inference beam and the beam quality corresponding to the inference beam is in front or back of the bit field corresponding to the actual beam and the beam quality corresponding to the actual beam.

10. (canceled)

11. (canceled)

12. The method of claim 7, wherein the second type of parameters comprises at least one of a structure parameter of the trained data processing model, a weight factor of the trained data processing model, or a bias factor of the trained data processing model.

13. The method of claim 1, further comprising at least one of:
transmitting, to the network device, the report for acquiring the information associated with the data processing model; or
in accordance with a determination that a failure is detected in the data processing model, causing a transmission of the report to be skipped.

14. The method of claim 13, further comprising at least one of:
in accordance with a determination that a failure is detected in the data processing model, transmitting, to the network device, the report, wherein a bit field corresponding to the report is set to a predetermined number,
or
in accordance with a determination that second uplink information needs to be transmitted, determining whether the second uplink information collides with the report;
in accordance with a determination that the second uplink information collides with the report, comparing a first priority of the report and a second priority of the second uplink information; and
in accordance with a determination that the first priority is higher than the second priority, transmitting the report to the network device.

15. (canceled)

16. (canceled)

17. The method of claim 14, wherein at least one of:
the first priority and the second priority are determined from a set of values, wherein the set of values comprises 0, 1 or 2; or
the report comprises at least one of: a periodic channel state information (CSI) report, a semi-persistent CSI report or an aperiodic CSI report.

18. The method of claim 1, further comprising:
in accordance with a determination that at least one condition is fulfilled, determining that a failure occurs on the data processing model.

19. The method of claim 18, wherein the at least one condition comprises one of:
a first condition where a first target beam determined based on the data processing model is different from a second target beam determined based on the measurement of a set of reference signals associated with the report;
a second condition where a difference between a beam quantity of the first target beam and a beam quantity of the second target beam exceeds a first threshold value; or
a third condition where the number of the first condition or the second condition being fulfilled exceeds a second threshold value.

20. (canceled)

21. A communication method, comprising:
receiving, at a network device and from a terminal device, a capability report comprising one or more capabilities of the terminal device, wherein the one or more capabilities at least indicate that the terminal device supports a data processing model;
transmitting, to the terminal device, one or more configurations associated with the data processing model; and
transmitting, to the terminal device, an indication for triggering a report for acquiring information associated with the data processing model.

22. (canceled)

23. (canceled)

24. (canceled)

25. (canceled)

26. The method of claim 21, wherein the report is associated with the one or more configurations associated with the data processing model.

27. (canceled)

28. (canceled)

29. (canceled)

30. (canceled)

31. (canceled)

32. (canceled)

33. The method of claim 21, further comprising:
receiving, from the terminal device, the report for acquiring the information associated with the data processing model.

34. The method of claim 33, further comprising:
in accordance with a determination that a failure is detected in the data processing model, receiving, from the terminal device, the report, wherein a bit field corresponding to the report is set to a predetermined number.

35. A terminal device comprising:
a processor; and
a memory coupled to the processor and storing instructions thereon, the instructions, when executed by the processor, causing the terminal device;
report, to a network device, one or more capabilities of the terminal device, wherein the one or more capabilities at least indicate that the terminal device supports a data processing model;
receive, from the network device, one or more configurations associated with the data processing model; and
receive, from the network device, an indication for triggering a report for acquiring information associated with the data processing model.

36. (canceled)

37. (canceled)
